(19) United States
(12) Patent Application Publication
(10) Pub. No.: US 2025/0197587 A1
(43) Pub. Date: Jun. 19, 2025

(54) PREPARATION METHOD OF WEAR-RESISTANT POLYESTER MATERIAL

(71) Applicant: NAN YA PLASTICS CORPORATION, Taipei City (TW)

(72) Inventors: Te-Chao Liao, Taipei City (TW); Wen-Cheng Yang, Taipei City (TW); Chun-Che Tsao, Taipei City (TW); Chia-Yen Hsiao, Taipei City (TW); Ci Syuan Liou, Taipei City (TW)

(73) Assignee: NAN YA PLASTICS CORPORATION, Taipei City (TW)

(21) Appl. No.: 18/413,047

(22) Filed: Jan. 16, 2024

(30) Foreign Application Priority Data
Dec. 14, 2023 (TW) 112148837

(51) Int. Cl. C08J 11/06; B29B 9/06; B29B 9/12; B29B 17/04; B29K 67/00; B29K 105/00; B29K 105/26; C08K 3/01; C08K 5/00; C08K 13/02; C08L 67/02

(52) U.S. Cl. CPC C08J 11/06; B29B 9/12; B29B 17/0412; C08K 13/02; C08L 67/02; B29B 9/06; B29K 2067/00; B29K 2105/0044; B29K 2105/26; C08J 2367/02; C08K 3/01; C08K 5/0016; C08K 5/005; C08K 5/0083; C08L 2201/08; C08L 2205/06; C08L 2205/24; C08L 2207/20

(57) ABSTRACT

The disclosure provides a preparation method of polyester material, which is a continuous process and includes the following steps. A recycled release film is crushed, compacted and dried, and then melted, extruded and degassed. After filtration, a liquid viscosifying system is used for thickening. After that, it is melted and kneaded, modified with modifiers and extruded, and then pelletized and dehydrated to make the polyester material, wherein the modifiers include nucleating agents, lubricants and antioxidants.

### CROSS-REFERENCE TO RELATED APPLICATION

This application claims the priority benefit of Taiwan application serial no. 112148837, filed on Dec. 14, 2023. The entirety of the above-mentioned patent application is hereby incorporated by reference herein and made a part of this specification.

### BACKGROUND

### Technical Field

The disclosure relates to a preparation method of a polyester material, and in particular, to a preparation method of a wear-resistant polyester material.

### Description of Related Art

In the future, the market will gradually lead to the trend of circular economy and plastic recycling and reuse. Under this market trend, single-material products and the introduction of recycled materials are important goals for future development. The introduction of recycled materials is to introduce environmentally friendly recycled materials without affecting the mechanical properties and processability, which will help achieve the goal of global carbon reduction and energy saving. The single nature of the product means that the materials used in the product are singled out. When the service life of product is reached, it can be directly recycled and remanufactured, so as to avoid poor recyclability due to mixing of different materials.

In order to realize the single-material product, POM, nylon and other fasteners or peripheral accessories must be replaced with PET polyester materials. However, unmodified PET materials have slow crystallization speed, insufficient heat resistance, and large friction coefficient, making them difficult to be directly used for injection replacement of POM, nylon and other products.

In the existing technical field of wear-resistant polyester material preparation methods, a segmented process is mainly adopted, which is inefficient and high-energy-consuming. More particularly, for example, process one, process two and process three can be carried out in a segmented manner. In the process one, the recycled release film is crushed, the broken film is compacted and dried, and then melted, extruded and degassed. After filtering, pelletizing and dehydration, low-viscosity PET recycled granules can be obtained. After that, process two is carried out. In process two, the low-viscosity PET recycled granules are solid-state polymerized and mixed with an expansion agent to form medium- and high-viscosity PET recycled granules. Finally, process three is carried out. In process three, the medium- and high-viscosity PET recycled granules are melted, kneaded, extruded and modified using a modifier, and then pelletized and dehydrated to obtain a high-strength flame-retardant polyester material.

Based on the above, developing a preparation method of wear-resistant polyester materials, so as to improve production efficiency and reduce energy consumption, thereby complying with the global environmental protection trend of plastic reduction and energy conservation, is an important topic currently required for research.

### SUMMARY

The invention provides a preparation method of polyester materials, which mainly adopts a continuous process with high efficiency and low energy consumption. It can generate highly crystalline and wear-resistant polyester materials, improve the problems of slow crystallization speed and insufficient heat resistance of PET materials, and reduce the friction coefficient of the PET material surface to improve its wear resistance.

The disclosure provides a preparation method of polyester material, which is a continuous process and includes the following steps. A recycled release film is crushed, compacted and dried, and then melted, extruded and degassed. After filtration, a liquid viscosifying system is used for thickening. After that, it is melted and kneaded, modified with modifiers and extruded, and then pelletized and dehydrated to make the polyester material, wherein the modifiers include nucleating agents, lubricants and antioxidants.

In an embodiment of the disclosure, a wear loss of the polyester material is less than 300 mg.

In an embodiment of the disclosure, the preparation method further includes removing a surface coating of the recycled release film using a film surface ceramic slurry removal technology before the recycled release film is crushed, compacted and dried.

In an embodiment of the disclosure, the liquid viscosifying system is used to increase an intrinsic viscosity (IV) from a viscosity range of 0.5 dl/g to 0.62 dl/g to a viscosity range of 0.7 dl/g to 0.92 dl/g.

In an embodiment of the disclosure, a temperature at which the recycled release film is crushed, compacted and dried is 100° C. to 160° C.

In an embodiment of the disclosure, a temperature of melting, extruding and degassing is 240° C. to 280° C.

In an embodiment of the disclosure, a temperature of melting and kneading is 230° C. to 275° C.

In an embodiment of the disclosure, a temperature of modification and extruding is 230° C. to 280° C.

In an embodiment of the disclosure, the nucleating agents include organic nucleating agents, inorganic nucleating agents or blends thereof.

In an embodiment of the disclosure, the organic nucleating agents include organic sodium salts, the organic sodium salts include sodium benzoate, sodium montanate or ethylene-methacrylic acid copolymer (EMAA).

In an embodiment of the disclosure, the inorganic nucleating agents include inorganic micro-nano powders, the inorganic micro-nano powders include talc, titanium dioxide, silica or calcium carbonate.

In an embodiment of the disclosure, the antioxidants include hindered phenolic antioxidants, phenolic antioxidants, mixed antioxidants, phosphite antioxidants, complex antioxidants or combinations thereof.

In an embodiment of the disclosure, the lubricant comprises stearates, polyethylene wax, siloxane modifier, or a fluorine-based resin.

In an embodiment of the disclosure, based on a total weight of the polyester material, an added amount of the nucleating agents is 0.5 wt % to 3 wt %, an added amount of the antioxidants is 0.1 wt % to 1 wt %, and an added amount of the lubricant is 0.05 wt % to 1 wt %.

Based on the above, the disclosure provides a preparation method of polyester materials, which mainly adopts a continuous process with high efficiency and low energy consumption. It can generate highly crystalline and wear-resistant polyester materials, improve the slow crystallization speed and heat resistance insufficient problem of PET materials, and reduce the friction coefficient of PET material surface to improve its wear resistance. The wear-resistant polyester material prepared by the disclosure can be used in zippers, buckles, curtain parts, stationery, machine casings, etc. to achieve the goal of single material.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

The disclosure provides a preparation method of polyester material, which is a continuous process and includes the following steps. First, a surface coating of a recycled release film is removed using a film surface ceramic slurry removal technology. Next, a recycled release film is crushed, compacted and dried, and then melted, extruded and degassed. After filtration, a liquid viscosifying system is used for thickening. After that, it is melted and kneaded, modified with modifiers and extruded, and then pelletized and dehydrated to make the polyester material, wherein a wear loss of the polyester material is less than 300 mg.

In the present embodiment, a liquid viscosifying system is used to increase the intrinsic viscosity (IV) from a viscosity range of 0.5 dl/g to 0.62 dl/g to a viscosity range of 0.7 dl/g to 0.92 dl/g. As a result, the mechanical properties, flame retardancy and fluidity of environmentally friendly recycled granules can be equivalent to those of virgin granules.

In the present embodiment, a temperature for crushing, compacting and drying the recycled release film is, for example, 100° C. to 160° C.; a temperature of melting, extruding and degassing is, for example, 240° C. to 280° C.; a temperature of melting and kneading is, for example, 230° C. to 275° C.; and a temperature of modification and extruding is, for example, 230° C. to 280° C. In the present embodiment, modifiers can include nucleating agents, lubricants and

antioxidants. Below, the various components mentioned above will be described in detail.

### Nucleating Agents

In the present embodiment, the nucleating agents can include organic nucleating agents, inorganic nucleating agents or blends thereof. The organic nucleating agents include organic sodium salts, and the organic sodium salts include sodium benzoate, sodium montanate or ethylene-methacrylic acid copolymer (EMAA). The inorganic nucleating agents include inorganic micro-nano powders, and the inorganic micro-nano powders include talc, titanium dioxide, silica or calcium carbonate. Based on a total weight of the polyester material, an added amount of the nucleating agents is 0.5 wt % to 3 wt %, for example. Preferably, an added amount of the nucleating agents is 1 wt % to 2 wt %, for example. Adding nucleating agents can increase the crystallization and solidification speed of PET materials, thereby improving its processability.

### Lubricants

In the present embodiment, the lubricant may include stearates, polyethylene wax, siloxane modifier, or a fluorine-based resin. The lubricant is added in an amount of, for example, 0.05% by weight to 1% by weight based on a total weight of the polyester material. By adding the lubricant, the surface friction coefficient can be reduced and the wear resistance of the product can be improved.

### Antioxidant

In the present embodiment, an antioxidant may include a hindered phenol antioxidant, a phenol antioxidant, a hybrid antioxidant, a phosphite antioxidant, a compound antioxidant or a combination thereof. Based on a total weight of the polyester material, an added amount of the antioxidant is 0.1 wt % to 1 wt %, for example. The antioxidant can improve the heat resistance and processability of the material.

Below, the above-mentioned preparation method of a wear-resistant polyester material of the disclosure is described in detail by experimental example. However, the following experimental examples are not intended to limit the disclosure.

### Experimental Examples

In order to prove that the preparation method of polyester material proposed by the disclosure can produce a wear-resistant polyester material, reduce the surface friction coefficient of PET materials to improve its wear resistance, this experimental example is specially performed below.

### Test Methods

Tensile strength: ASTM D638
Bending strength, bending modulus: ASTM D790

### Material Property Evaluation

POM, unmodified PET and polyester materials produced by the preparation method of the disclosure were tested according to the above test method, and the test results are listed in Table 1 below. Since the preparation method of the polyester material of the disclosure has been described in detail above, it will not be described in detail here. The preparation conditions for the polyester material produced by the preparation method of the disclosure in Table 1 are as follows: a liquid viscosifying system is used for thickening, the intrinsic viscosity (IV) is increased to 0.82 dl/g, the release film is recycled, crushed, compacted and dried at 120° C., the temperature for melt extrusion and degassing is 255° C., the temperature for melting and kneading is 265° C., and the temperature for modification and extrusion is 265° C.; based on the total weight of the polyester material, the amount of nucleating agents added is 1.2 wt %, the amount of lubricant added is 0.7 wt %, and the amount of antioxidant added is 0.7 wt %.

As can be seen from Table 1 below, the polyester material produced by the preparation method of the disclosure has good mechanical properties and wear resistance, and the wear loss of the polyester material is less than 300 mg. The disclosure mainly reduces the surface friction coefficient and improves the wear-resistant characteristics of the product by adding lubricant; adding antioxidants to improve the heat resistance and processability of the material; adding nucleating agents can increase the crystallization and solidification speed of the PET material, and effectively improve shrinkage rate.

TABLE 1

| | | | | Polyester |
|---|---|---|---|---|
| | | | | material |
| | | | Unmodified | of the |
| | | POM | PET | disclosure |
| Mechanical | Impact strength | 4.9 | 3.4 | 3.6 |
| properties | (kg-cm/cm) | | | |
| | Tensile strength | 63.0 | 57.2 | 63.8 |
| | (MPa) | | | |
| | Bending strength | 88.0 | 88.1 | 96.2 |
| | (MPa) | | | |
| | Bending modulus | 2550 | 2400 | 2650 |
| | (MPa) | | | |

| | | | |
|---|---|---|---|
| T_{hc}(° C.) | — | 186.7 | 208.7 |
| Surface hardness | HB | HB | HB |
| Rockwell hardness | 108 | 102 | 102 |
| Static/dynamic friction | 0.37/0.32 | 0.48/0.40 | 0.40/0.34 |
| coefficient | | | |
| Abrasion loss (mg) | 444.6 | 381.7 | 298.6 |
| (H-22 wheel, load | | | |
| 1 kg, 2000 times) | | | |

In summary, the disclosure provides a preparation method of a wear-resistant polyester material, which mainly adopts a continuous process with high efficiency and low energy consumption, and has the advantages of low carbon emissions, so as to generate a high-performance crystallized wear-resistant polyester material for single-material applications, which improves the problems of slow crystallization speed and insufficient heat resistance of PET materials, and reduces the surface friction coefficient of PET materials to improve its wear resistance. The wear-resistant polyester material prepared by the disclosure can be used in zippers, buckles, curtain parts, stationery, machine casings, etc. to achieve the goal of single material. On the other hand, the disclosure uses recycled release film as PET raw material, and its mechanical properties, wear resistance and fluidity are equivalent to virgin pellets. Therefore, it will contribute to the global goal of plastic reduction and energy saving.

What is claimed is:

1. A preparation method of a polyester material, which is a continuous process, comprising:
crushing, compacting and drying a recycled release film, and then melting, extruding and degassing the recycled release film;
after filtration, using a liquid viscosifying system for thickening; and
performing melting and kneading, and modifiers are used for modification and extruding, and then pelletizing and dehydrating to make the polyester material, wherein the modifiers include nucleating agents, lubricants and antioxidants.

2. The preparation method of the polyester material according to claim 1, wherein a wear loss of the polyester material is less than 300 mg.

3. The preparation method of the polyester material according to claim 1, further comprising removing a surface coating of the recycled release film using a film surface ceramic slurry removal technology before the recycled release film is crushed, compacted and dried.

4. The preparation method of the polyester material according to claim 1, wherein the liquid viscosifying system is used to increase an intrinsic viscosity (IV) from a viscosity range of 0.5 dl/g to 0.62 dl/g to a viscosity range of 0.7 dl/g to 0.92 dl/g.

5. The preparation method of the polyester material according to claim 1, wherein a temperature at which the recycled release film is crushed, compacted and dried is 100° C. to 160° C.

6. The preparation method of the polyester material according to claim 1, wherein a temperature of melting, extruding and degassing is 240° C. to 280° C.

7. The preparation method of the polyester material according to claim 1, wherein a temperature of melting and kneading is 230° C. to 275° C.

8. The preparation method of the polyester material according to claim 1, wherein a temperature of modification and extruding is 230° C. to 280° C.

9. The preparation method of the polyester material according to claim 1, wherein the nucleating agents include organic nucleating agents, inorganic nucleating agents or blends thereof.

10. The preparation method of the polyester material according to claim 9, wherein the organic nucleating agents include organic sodium salts, the organic sodium salts include sodium benzoate, sodium montanate or ethylene-methacrylic acid copolymer (EMAA).

11. The preparation method of the polyester material according to claim 9, wherein the inorganic nucleating agents include inorganic micro-nano powders, the inorganic micro-nano powders include talc, titanium dioxide, silica or calcium carbonate.

12. The preparation method of the polyester material according to claim 1, wherein the antioxidants include hindered phenolic antioxidants, phenolic antioxidants, mixed antioxidants, phosphite antioxidants, complex antioxidants or combinations thereof.

13. The preparation method of the polyester material according to claim 1, wherein the lubricant comprises stearates, polyethylene wax, siloxane modifier, or a fluorine-based resin.

14. The preparation method of the polyester material according to claim 1, wherein based on a total weight of the polyester material, an added amount of the nucleating agents is 0.5 wt % to 3 wt %, an added amount of the antioxidants is 0.1 wt % to 1 wt %, and an added amount of the lubricant is 0.05 wt % to 1 wt %.
